(19) United States
(12) Patent Application Publication
(10) Pub. No.: US 2010/0254657 A1
(43) Pub. Date: Oct. 7, 2010

(54) Attenuator coupling for laser systems

(75) Inventors: Densen Cao, Sandy, UT (US); Zhaohui Lin, Salt Lake City, UT (US); Douglas Beattie, JR., South Jordan, UT (US)

Correspondence Address: MARCUS G THEODORE, PC, 466 SOUTH 500 EAST, SALT LAKE CITY, UT, 84102, US

(73) Assignee: CAO Group, Inc., West Jordan, UT (US)

(21) Appl. No.: 12/384,332

(22) Filed: Apr. 1, 2009

(51) Int. Cl. G02B 6/26

(52) U.S. Cl. 385/50

(57) ABSTRACT

A laser attenuator with a coupling mechanism to control laser emissions of fiber lasers.

### BACKGROUND OF THE INVENTION

1. Field

This invention pertains to laser systems with fiber optic cables removably attached to a housing laser port. In particular it relates to a fiber optic coupler, which also acts as an electrical switch to prevent accidental laser beam exposure when the optic cable is not properly secured.

2. State of the Art

Laser systems are used for many applications in the medical, dental, veterinary, and semiconductor process industries including inspections, measurements, detections, etc. A laser system has a power source, which generates light in a gain medium inside a highly reflective optical cavity. The gain medium is a material with properties that allow it to amplify light by stimulated emission. In its simplest form, the reflective cavity consists of two mirrors arranged such that light bounces back and forth, each time passing through the gain medium. Typically one of the two mirrors, the output coupler, is partially transparent releasing an output laser beam through this output coupler mirror. Thus light of a specific wavelength passes through the gain medium for amplification (increases in power) with each reflective pass via pumping. The surrounding mirrors ensure that most of the light makes many passes through the gain medium for repeated amplification.

The output coupler thus generates a high intensity laser beam directed through delivery means such as fiber optics, optics, and other devices to deliver the laser beam to desired locations from the system. Solid-state lasers where the light is guided due to the total internal reflection in an optical fiber are called fiber lasers. Guiding of light allows extremely long gain regions providing good cooling conditions. This results because the optical fibers have high surface area to volume ratio which allows efficient cooling. In addition, the optical fiber's wave guiding properties tend to reduce thermal distortion of the beam.

The produced laser beam is hazardous to human eyes, skin and other organs. Protective gear is therefore required for an operator when operating the laser system. In addition, for safety purposes, a laser beam attenuator is required in the laser beam delivery system to stop laser beam delivery or stop laser system activation when the laser system is not intended for use. In the past, most attenuators in current laser beam deliver system use physical mean to stop the laser beam. A physical object made of metal, plastic, or other laser beam resistant materials is placed in the path of laser beam using mechanical means. Such blocking means are effective. However, they are not 100% secure. If the physical object is broken or detached, the laser beam protection for laser system fails.

Other laser systems employ a laser to fiber coupler with electrically controlled attenuators, such as those produced by Oz Optics Ltd of Ontario, Canada.

The present invention discloses a combination electronic plus mechanical method for laser attenuation.

### SUMMARY OF THE INVENTION

The invention comprises a laser attenuator with a coupling mechanism to control laser emissions of fiber lasers. Fiber lasers have a housing defining a laser port. They are operably associated with a power source controlled by an electrical circuit. The power source powers a light generator, which passes light through the gain medium inside a highly reflective optical cavity to pump and create a laser beam. This laser beam is projected through a housing laser port into an optical cable laser system for various applications. Because of the intensity of laser beam exposure, the present invention is a combined electronic plus mechanical method for laser attenuation to insure that the laser is only activated, when needed, and directed through a laser shielded laser system.

Specifically, the invention utilizes a housing coupling defining an interior laser beam passageway affixed to the housing to align the laser beam passageway in communication with the laser port. This housing coupling has optical fiber attachment means to secure removably to an optical cable of a laser hand piece, articulated light source, laser heads, and other laser shielded delivery systems.

Electrical leads with spaced apart contact ends are associated with the optical fiber attachment means of the housing coupling in a manner such that the electrical leads are operably associated with the electrical circuit controlling the power source to form an open loop connection, which will not activate the laser until the optical cable is properly attached to the housing coupling to prevent leakage.

A removable optical fiber coupling defining an interior laser beam passageway is then attached to the optical fiber cable of the laser delivery system via a first attachment end. This first attachment end is structured to attach to and align the laser beam passageway of the optical fiber coupling with the optical fiber cable. The other second attachment end of the optical fiber coupling has electrical conductive contact structure to removably contact the spaced apart contact ends of the electrical leads associated with the optical fiber attachment means. This completes an electric circuit when connected to the housing coupling so that the power source may be activated to transmit a laser beam through the optical fiber cable.

The invention provides an electronic coupling switch for laser attenuation, which prevents premature generation of laser beams through an unshielded laser port. It thus simultaneously employs mechanical control over the laser beam by only directing it through shielded laser delivery systems, as well as control over the activating circuit. Thus, the couplings form connections impervious to laser beam scattering before being directed through the laser delivery system.

To further control generated laser beams, an interior optical fiber cable may be employed in communication with the optical cavity and operably associated with the laser port to transmit laser beams through the laser port via interior optical fiber cable to prevent interior damage to the laser housing components.

The exterior removable optical fiber coupling may have one end permanently attached to the optical fiber cable. In this embodiment, the removable coupling attachment ends are structured to connect to the housing coupling. Preferably, the housing coupling is also structured to connect without twisting the optical fiber cable.

In one preferred embodiment, the laser attenuator with a coupling mechanism to control laser emissions of fiber lasers has a housing with an exterior and an interior and defines a laser port. Mounted within the housing interior is a light generator to pass light through a gain medium inside a highly reflective optical cavity to project a laser beam through an interior optical fiber cable with an end. The light generator is associated with a power source controlled by an internal electrical circuit.

An electrically conductive coupling defining a light passageway with first and second attachment ends is structured and adapted to attach to and pass a laser beam through the laser port of the housing.

An electrically conductive fastener is adapted to connect the end of the interior optical fiber cable to the first attachment end of the electrically conductive coupling so the optical fiber cable is in communication with the light passageway of the electrically conductive fastener to direct a laser beam through the laser port. This electrically conductive faster has a lead connected to the electrical circuit controlling the power source.

An insulated fiber coupler with a center hole is positioned over the second end of the electrically conductive fastener on the housing exterior. This fiber coupler has an exterior conductive coating contact surface with an insulated lead connected to the electrical circuit controlling the power source forming an open loop connection with the conductive fastener lead.

A fiber cable coupler with a conductive end and an attachment end is removably attached to the end of a fiber cable of a laser system. The conductive end is structured to removably attach to the electrically conductive fastener and make electrical contact with the conductive coating contact surface of the insulated fiber coupler to complete the activation circuit, when connected.

In another embodiment, the insulated fiber coupler is structured as an insulation disc with a leading passing through the insulation disc to contact the coating surface.

In another embodiment, the end of the interior optical fiber cable and the first end of the electrically conductive coupling are correspondingly threaded to form a laser light impervious connection. In addition to being laser light impervious, these couplings are preferably structured to connect without twisting the optical fiber cable.

The invention thus provides an electronic plus mechanical method for laser attenuation and shielding.

### DESCRIPTION OF THE DRAWINGS

FIG. 1 is a flow diagram of a typical fiber laser system employing the improved attenuator.

FIG. 2 is an exploded view of a preferred embodiment of a laser delivery system with the improved attenuator.

FIG. 3 is an assembled view of the embodiment of FIG. 3.

FIG. 4 is a cross sectional view of the electrical switch of FIG. 3.

### DESCRIPTION OF THE ILLUSTRATED EMBODIMENTS

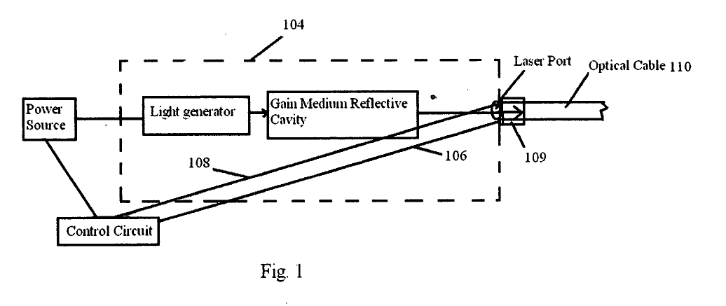

FIG. 1 is a flow diagram of a typical fiber laser system employing the improved attenuator with optical fiber connector coupling. The fiber laser system has a housing containing a laser source shown as a light generator operably associated with a gain medium reflective cavity, which generates a laser beam and directs it through a laser port in the housing 104. The light generator and gain medium reflective cavity are powered by a power source controlled by an electrical circuit. In applicant's invention, the electrical control circuit is associated with electrical leads 106, 108 of a cable connector 109, such that the circuit is open until the connector 109 properly seats the optical cable in position; thereby electrically contacting the leads to close the circuit so that the fiber laser system may be activated.

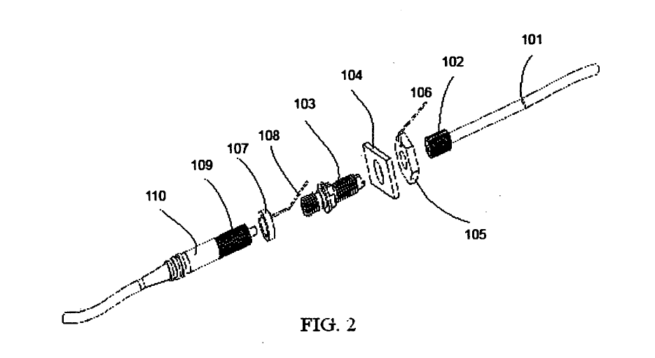

FIG. 2 is an exploded view of a preferred embodiment of a laser delivery system with an improved attenuator. Starting from the right, a fiber cable 101 is connected to a laser source, such as the light generator operatively associated with the gain medium reflective cavity. The fiber cable 101 has a fastener 102 to attach the fiber cable 101 to a fiber cable coupler 103 which is attached to a housing wall 104 defining a laser port surrounded by a fastener 105. The fastener 105 has a conduction wire 106 to attached, which is operably associated with the electrical circuit. An insulation disk 107 with one side coated with a conduction layer has a center opening to fit over the fiber cable coupler on the exterior of the housing wall 104 as shown. Wire lead 108 is connected with the disc 107 conduction layer to act as an electrical switch for the laser delivery system. Fiber cable fastener 109 is attached to laser delivery system 110 and includes electrical contacts, which completes the electrical circuit of the insulation disc 107 conduction layer, the coupler 103 and the conduction wire 106 to close the circuit when the fiber cable fastener 109 is attached.

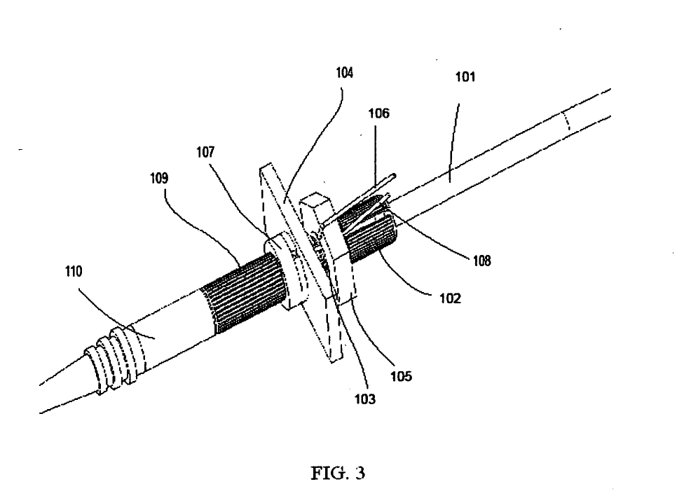

FIG. 3 illustrated the assembly view of the embodiment of FIG. 2.

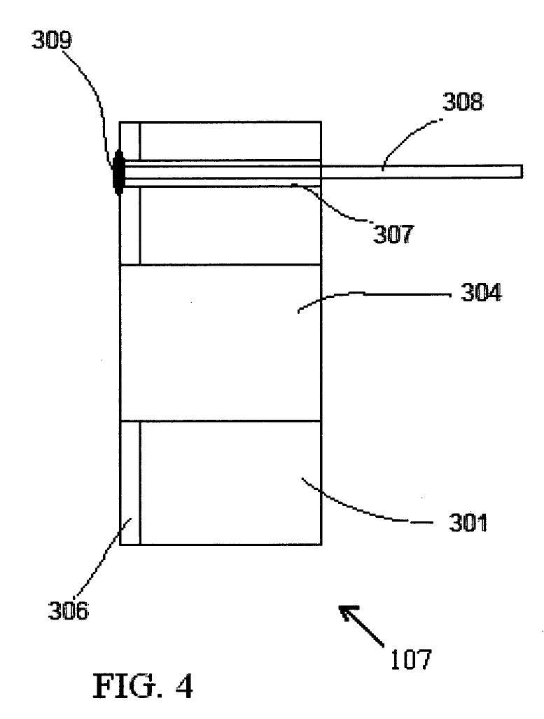

FIG. 4 is a cross sectional view of the electrical switch 107 of FIG. 3. The electrical switch 107 is constructed as an insulation disk 301 with defining a through hole 304. On the exterior if the disc 301 is a conductive coating layer 306 in communication with another through hole 307. A conduction wire 308 passes through hole 307 and is attached to conductive layer 306 by solder paste 309.

The fiber coupler 103 and fiber cable fastener 102 are made of electrical conduction materials like metals. Conduction wire leads 106 and 108 are operably associated with a laser control switch (not shown) which activates the laser source. When fastener 109 is attached to fiber coupler 103, contact with disk 107 results, forming a closed conduction loop electrical circuit for the laser control switch to activate. If fastener 109 is not attached to fiber coupler 103, there is no contact with disk 107. Consequently, the electrical circuit is an open loop so that the laser control switch cannot activate the laser source. The configuration thus provides an electronic plus mechanical method for laser attenuation and shielding, whereby a user is not exposed to an uncontrolled unshielded laser beam.

Although this specification has made reference to the illustrated embodiments, it is not intended to restrict the scope of the appended claims. The claims themselves recite those features deemed essential to the invention.

We claim:

1. A laser attenuator with a coupling mechanism to control laser emissions of fiber lasers having a housing defining a laser port and operably associated with a power source controlled by an electrical circuit to power a light generator passing light through a gain medium inside a highly reflective optical cavity to create and project a laser beam through the laser port, comprising:
a. a housing coupling defining an interior laser beam passageway with optical fiber attachment means affixed to the housing to align the laser beam passageway in communication with the laser port,
b. electrical leads with spaced apart contact ends associated with the optical fiber attachment means, such that the electrical leads are operably associated with the electrical circuit controlling the power source to form an open loop connection, and
c. a removable optical fiber coupling defining an interior laser beam passageway, with a first attachment end which attaches to and aligns the laser beam passageway with an optical fiber cable, and a second attachment end having electrical conductive contact structure to removably contact the spaced apart contact ends of the electrical leads to complete an electric circuit when connected to the housing coupling so that the power source may be activated to transmit a laser beam through the optical fiber cable.

2. A laser attenuator with a coupling mechanism according to claim 1, wherein the couplings form connections impervious to laser beam scattering.

3. A laser attenuator with a coupling mechanism according to claim 1, including an interior optical fiber cable in communication with the optical cavity and operably associated with the laser port to transmit laser beams there through.

4. A laser attenuator with a coupling mechanism according to claim 1, wherein the removable optical fiber coupling has one end permanently attached to the optical fiber cable.

5. A laser attenuator with a coupling mechanism according to claim 1, wherein the removable coupling attachment ends are structured to connect without twisting the optical fiber cable.

6. A laser attenuator with a coupling mechanism to control laser emissions of fiber lasers having a housing with an exterior and an interior defining a laser port and containing a power source controlled by an electrical circuit to power a light generator through a gain medium inside a highly reflective optical cavity to project a laser beam through an interior optical fiber cable with an end, comprising:
a. an electrically conductive coupling defining a light passageway with first and second attachment ends adapted to pass through the laser port,
b. an electrically conductive fastener adapted to connect the end of the interior optical fiber cable to the first attachment end of the electrically conductive coupling so the optical fiber cable is in communication with the light passageway of the electrically conductive fastener to direct a laser beam through the laser port, the electrically conductive faster having a wire lead connected to the electrical circuit controlling the power source,
c. an insulated fiber coupler with a center hole positioned over the second end of the electrically conductive fastener proximate the housing exterior, having an exterior conductive coating contact surface with an insulated wire lead connected to the electrical circuit controlling the power source forming an open loop connection, and
d. a fiber cable coupler with a conductive end and an attachment end removably attachable to the end of a fiber cable, the conductive end structured to removably attach to the electrically conductive fastener and make contact with the conductive coating contact surface of the insulated fiber coupler to complete the activation circuit, when connected.

7. A laser attenuator coupling mechanism according to claim 6, wherein the insulated fiber coupler is structured as an insulation disc with a wire lead passing through the insulation disc to contact the coating contact surface.

8. A laser attenuator coupling mechanism according to claim 6, wherein the end of the interior optical fiber cable and the first attachment end of the electrically conductive coupling are correspondingly threaded.

9. A laser attenuator coupling mechanism according to claim 8, wherein the end of the interior optical fiber cable and the first attachment end are structured to connect without twisting the optical fiber cable.
